(19) United States
(12) Patent Application Publication
(10) Pub. No.: US 2026/0236216 A1
(43) Pub. Date: Aug. 13, 2026

(54) USAGE-WEIGHTED INFLUENCE METRICS FOR BROADCAST STREAMS

(71) Applicant: SynQ Inc., Los Angeles, CA (US)

(72) Inventors: Jesse Ugochukwu Ugwuegbu, Los Angeles, CA (US); Joshua Xavior-Paul Hicks, Modesto, CA (US); Reginald Jonathan Peacock II, San Francisco, CA (US); James M. Behmke, Boston, MA (US)

(21) Appl. No.: 19/379,735

(22) Filed: Nov. 4, 2025

Related U.S. Application Data
(60) Provisional application No. 63/716,065, filed on Nov. 4, 2024.

(51) Int. Cl. G06F 3/16

(52) U.S. Cl. CPC G06F 3/165

(57) ABSTRACT

A system and method for generating usage-weighted influence metrics in synchronized broadcast environments are described. Listener devices transmit periodic playback telemetry including timestamps and session identifiers to a control server, which aggregates data to form a listener-count time series. A cumulative engagement metric, termed SynQ Minutes, is calculated by integrating listener count over the playback duration of each track. Additional analytics including join rate, leave rate, and momentum index quantify engagement trends and inflection points. Metrics are stored in an analytics database for visualization and longitudinal trend analysis, enabling statistically accurate measurement of audience interaction and influence.

### RELATED APPLICATION

This non-provisional application claims priority to U.S. Provisional Patent Appl. Ser. No. 63/716,065, filed on Nov. 4, 2024, entitled “INTEGRATED MUSIC STREAMING AND SOCIAL MEDIA APPLICATION WITH SYNCHRONOUS MULTI-USER LISTENING CAPABILITIES” by Jesse Ugwuegbu, et al., the contents of which being incorporated by reference herein in its entirety.

### TECHNICAL FIELD

The present disclosure pertains to the field of digital audio entertainment platforms, specifically focusing on an innovative music streaming application with integrated social features including usage-weighted influence metrics for broadcast streams.

### BACKGROUND

The evolution of computer and cellular phone compatible music streaming applications has marked a significant paradigm shift in the way people consume music, fundamentally transforming the music industry. These applications operate on the premise of granting users immediate access to an extensive library of songs through both computer and mobile devices. The underlying technical aspects of these platforms involve sophisticated audio codecs, such as Advanced Audio Coding (AAC) and Ogg Vorbis, for compressing music files without compromising quality. Streaming services often employ adaptive bitrate streaming (ABR) to dynamically adjust the bitrate based on users' internet speeds, ensuring a seamless listening experience. Content delivery networks (CDNs) are utilized to distribute music content globally, minimizing latency and optimizing speed. Digital rights management (DRM) technologies are implemented to safeguard intellectual property by controlling access and usage of copyrighted material.

The revolutionary impact of music streaming apps lies in their ability to provide unparalleled access, convenience, and personalization to users. The elimination of physical media and the shift away from individual song purchases have democratized access to an immense catalog of music. Algorithm-driven personalized playlists and recommendations cater to individual preferences, enhancing the overall listening experience. In essence, the advent of computer and cellular phone compatible music streaming applications has not only streamlined music consumption but has also redefined the ways in which individuals engage with and enjoy music on a global scale.

However, the current landscape of mainstream music streaming applications primarily focuses on providing individualized music experiences without placing a significant emphasis on connecting users socially, akin to the interactive nature of social media platforms. Unlike social media apps that facilitate direct interactions, comments, and sharing of content, traditional music streaming apps often lack features that foster real-time social connections among users and artists.

### SUMMARY

According to various embodiments herein, components of an illustrative integrated music streaming and social media application with synchronous multi-user listening capabilities are introduced. In particular, the present disclosure may illustratively be based on a novel approach to enhancing the social aspect of music streaming that involves the introduction of features that enable synchronous listening experiences, hereinafter referred to as “listening parties.” The application designed with this functionality may allow users in different locations to share and synchronize their music playback in real-time. This innovative feature may enable users to create virtual spaces where friends or communities can collectively listen to the same song or playlist simultaneously, fostering a shared auditory experience.

Specifically, the present disclosure provides a method and system for deriving fine-grained engagement metrics within synchronized audio broadcast environments by continuously collecting playback telemetry from listener devices. Each device transmits periodic activity samples containing session identifiers, playback states, and timestamps. A control server aggregates this data across users to generate a time-series record of listener count versus time.

The system computes an integrated value (e.g., referred to as SynQ Minutes) representing the cumulative listening engagement for each track as the area under the listener-count curve during its playback interval. Additional analytics such as join rate, leave rate, and momentum index are derived from the same dataset, producing a multidimensional profile of audience interaction over time.

These influence metrics are stored in an analytics database and used to identify trends, evaluate session dynamics, and enhance discovery or ranking algorithms. The techniques herein therefore transform raw playback events into actionable, statistically precise engagement insights without reliance on external valuation or payment models.

Additional features of the present invention are discussed in the detailed description of the preferred embodiment below, and shown in the drawings hereof, and this summary is not meant to limit the scope of the embodiments herein.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of a block diagram of a system architecture including multiple user devices, a control server, a streaming server, and supporting network and database components configured to enable synchronized broadcast sessions and social interactions;

FIG. 2 illustrates an example of a block diagram of a device that may be used with one or more implementations described herein, e.g., as any of the nodes or devices shown in FIG. 1;

FIG. 3 illustrates an example of a user interface for a media collaboration application in accordance with one or more embodiments of the present disclosure;

FIG. 4 illustrates an example of a flowchart showing the initiation and synchronization process of a live broadcast session, including creation of a streaming channel, listener joining, and real-time audio alignment;

FIG. 5 illustrates an example of a logic diagram showing dynamic broadcast control transfer mechanisms, including open-access, administrative, and voting-based control policies;

FIG. 6 illustrates an example of a process flow diagram showing the periodic telemetry collection and reporting from user devices during synchronized playback sessions;

FIG. 7 illustrates an example of a graph depicting an example listener count over time for a particular song, illustrating the area-under-curve computation used to determine cumulative play minutes; and

FIG. 8 illustrates an example of a data aggregation diagram illustrating how individual telemetry inputs are aligned, normalized, and integrated by the control server to generate per-song and per-session influence metrics.

### DETAILED DESCRIPTION

The present disclosure may illustratively be considered in accordance with a media collaboration application (app), also referred to herein as the “SynQ” application, which can be implemented on a range of computing devices, including smartphones, tablets, laptops, and desktop computers, offering users a seamless, responsive experience across various platforms. On each device, the media collaboration app leverages the device's core components (e.g., a processor, memory, display, and audio system) to deliver high-quality audio playback, real-time interaction, and intuitive visual feedback. Mobile devices like smartphones and tablets are particularly suited for the social, on-the-go nature of the app, allowing users to tune into live listening sessions, vote, chat, and share music snippets anytime and anywhere. The app's interface adapts dynamically to different screen sizes and orientations, ensuring that each feature, from music streaming and playlist management to chat and polling, is easily accessible and visually engaging. For instance, on mobile devices, the app may use multi-touch gestures and quick-access menus, while on desktops and laptops, users might interact through mouse and keyboard inputs, all designed to maintain a unified experience regardless of the device.

The application harnesses the device's network connectivity and media broadcasting systems, whether through Wi-Fi or cellular data on mobile devices, to enable real-time interactions and content streaming. When streaming or “SynQing In/Out,” the app dynamically adjusts audio quality based on network conditions to ensure uninterrupted playback. Location-based features, such as proximity-based SynQ Spaces, leverage mobile devices'GPS capabilities to detect and connect users nearby. Additionally, smartphones and tablets can utilize near-field communication (NFC) for quick SynQ Space formation and QR codes for simplified joining, enabling quick connections in social or event-based settings. Each device's graphics processor and rendering capabilities ensure smooth visual transitions, such as the color changes in accordance with an engagement meter (e.g., “VibeCheQ” herein), and the display of user interactions within shared mediate spaces (e.g., “SynQ Spaces”), offering a visually rich and immersive experience.

Additionally, the media collaboration application operates within a distributed computer network and relies on a cloud-based server infrastructure to support its robust, real-time functionality. At the core, the media collaboration app employs a network of dedicated streaming servers that manage audio broadcasting and real-time synchronization across user devices. These servers handle the playback controls from users syncing out their playlists (e.g., “SynQers”), controlling music streams played for any number of listeners (e.g., “SynQees”), ensuring that commands like play, pause, or skip propagate instantly to all connected users within a SynQ Space. To manage high user traffic and enable scalable performance, the streaming servers may be load-balanced, distributing the audio streams evenly and dynamically adjusting based on demand to prevent latency or disruption during peak times.

A set of database servers manages user data, including profile information, playlists, comments, and play history. These servers may operate on a secure, redundant setup, ensuring data reliability and rapid retrieval of information for interactive features like hierarchical comments, music snippet posts, and performance tracking for leaderboards and badges. Additionally, these databases may store metadata for AI-driven components, enabling the app to suggest hashtags and adjust playlist options dynamically based on user engagement and preferences. For location-based features, the servers may integrate with geolocation APIs, or at least user-specified locations/tags, to identify and facilitate connections between nearby users, making it possible to synchronize audio streams for individuals within specific locations or events.

To support real-time interactions and minimize latency, the app's architecture may incorporate content delivery networks (CDNs) that cache frequently accessed media content, including popular audio snippets and artist spotlights. This setup ensures that users experience minimal delay in accessing high-demand content, even if they are located far from the primary data centers. The media collaboration app may also use dedicated notification and messaging servers that support the app's interactive features, enabling real-time updates for live commenting, polling, VibeCheQ ratings, etc. These servers may rely on WebSocket connections to push data instantly to devices, ensuring that users receive real-time updates without needing to refresh the app.

Security is a fundamental consideration within the media collaboration app's network architecture. The app may employ end-to-end encryption for audio streams and chat messages, ensuring user privacy and data integrity across the network. Servers may use secure access protocols and firewalls to guard against unauthorized access, with regular audits and updates to maintain compliance with data security standards. Together, this interconnected system of streaming, database, messaging, and CDN servers enables the media collaboration app to deliver a rich, immersive, and interactive music-sharing experience to users across a wide range of devices.

### System Architecture

The systems and methods described herein may be implemented within an integrated computing environment that includes user devices, one or more application servers, one or more streaming or broadcast servers, and a network infrastructure enabling real-time, low-latency communication among them. Together, these components provide the functionality necessary to support the interactive, synchronized, and socially enhanced music streaming experiences described in the present disclosures.

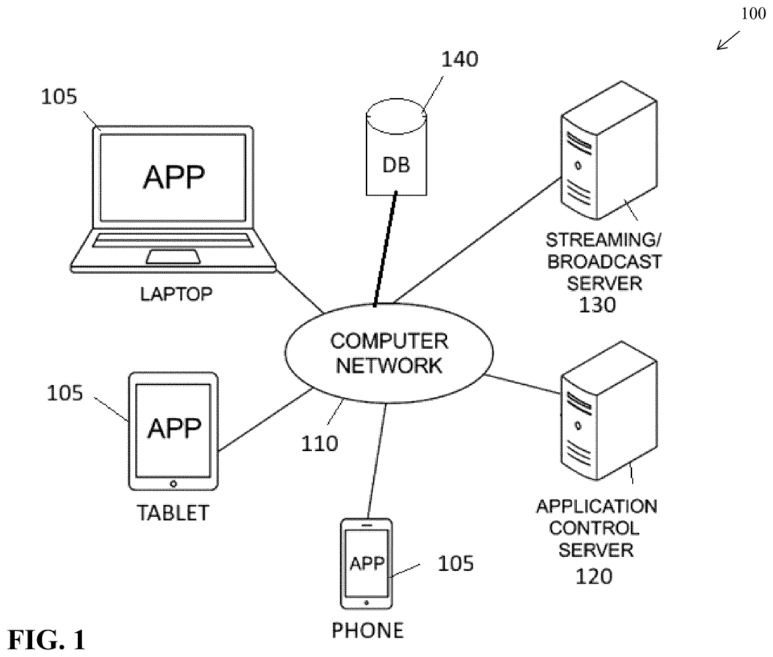

FIG. 1 depicts an example simplified architecture (computing system 100) of the synchronized social-streaming system herein. Multiple user devices (each a user device 105), such as smartphones, tablets, and laptops, connect through a communications network (computer network 110) to both an application control server 120 and a streaming/broadcast server 130 for the application. The streaming/broadcast server manages distribution of real-time audio content, while the control server handles session orchestration, playback synchronization, and social-interaction logic. Both servers may interface with a shared database (database 140) storing session data, playlists, analytics, and user profiles. Each user device executes an application (“APP”) that communicates bidirectionally with the servers, transmitting control inputs, playback states, and engagement events while receiving synchronized audio data and session updates. The network cloud (computer network 110) represents the broader communication infrastructure that enables low-latency coordination among participants, ensuring substantially simultaneous playback and shared social experiences.

As described herein, the user devices display an application interface that allows the user to start or join a broadcast session, view track information, and interact socially with other listeners. During operation, playback data is streamed directly from the streaming server, while the control server exchanges auxiliary information such as session identifiers, playback timestamps, and user actions (likes, comments, or control requests). Continuous data exchange may occur in both directions: audio streaming downstream and telemetry or engagement signals upstream. This arrangement separates time-critical media delivery from session logic, thereby improving responsiveness and synchronization accuracy across heterogeneous network conditions.

In particular, user devices provide real-time telemetry describing playback state, user inputs, and network latency. The control server aggregates this information to maintain session coherence, determine the currently active track, and broadcast control events to connected listeners. In parallel, the streaming server distributes encoded audio streams derived from the host playlist. Engagement and performance metrics collected at the control server are periodically stored in the database, where analytics modules compute aggregated measures such as listener count and participation rate.

Regarding the user devices 105, each user accesses the application through a computing device such as a smartphone, tablet, laptop, or desktop computer. The client-side application executes on the device's processor and leverages system resources including memory, display, audio subsystem, network interfaces, and optional positioning sensors. The application presents a graphical user interface through which the user can perform functions such as joining or initiating a shared streaming session (e.g., “SynQ session”), voting, commenting, generating hashtags, or sharing multimedia snippets. Mobile implementations employ touch input and gesture-based controls, while desktop implementations may use keyboard and mouse input, all with adaptive rendering that optimizes layout to screen size and orientation.

User devices 105 communicate with backend servers through wireless or wired networks using standard communication protocols (e.g., HTTPS, WebSocket, RTP, or WebRTC). The application dynamically adjusts streaming quality in response to available bandwidth to maintain a consistent user experience. Certain features, such as location-based discovery or proximity-based session joining, utilize device GPS, Wi-Fi triangulation, or NFC modules to identify nearby users and sessions. Other device sensors, such as accelerometers or microphones, may be optionally employed for additional interactive or analytical features. The client maintains a lightweight local cache for temporary song buffers, interaction logs, and session metadata, which are periodically synchronized with the backend servers.

The application control server 120 manages user authentication, session creation, access control, and synchronization of real-time events between users. It operates as the primary coordination point that tracks the state of each active SynQ Space, including the currently playing song, playback position, voting or comment activity, and participant list. The control server receives inputs from user devices (such as play/pause commands, votes, and comments), validates and timestamps them, and distributes authoritative state updates to all connected clients via push channels such as WebSocket or HTTP/2 streams. The same server also interfaces with persistent data stores for maintaining user profiles, playlists, chat histories, and analytics logs.

In some implementations, a separate streaming/broadcast server 130 is responsible for audio data delivery. As described in greater detail below, when a SynQer initiates a broadcast, the audio files selected by the user are uploaded or referenced through a “radio broadcast” microservice that generates a temporary streaming channel or URL corresponding to that session. Other users joining the session stream audio directly from this source, thereby hearing substantially the same content in real time. The broadcast server handles transcoding, buffering, and adaptive bitrate delivery to accommodate heterogeneous network conditions across devices. Multiple broadcast servers may be deployed behind a load balancer to ensure scalability and minimal latency, while an internal synchronization mechanism aligns playback timing across listeners with sub-second accuracy.

In alternative configurations, the streaming and application control functionalities may be co-located within a single physical or virtual server environment, depending on deployment scale and latency requirements. Both implementations support secure data exchange using encrypted channels.

Persistent storage may be maintained by database servers (database 140) that record structured data such as user credentials, playlists, comments, analytics logs, and SynQ session metadata. These databases may be replicated for redundancy and optimized for high-volume concurrent access. A messaging subsystem supports real-time chat, hierarchical comment threading, polling updates, and feedback events, all transmitted through publish-subscribe channels or message queues. For high-traffic media delivery, content delivery networks (CDNs) cache frequently accessed assets (such as popular songs, cover art, and trending snippet posts) closer to end users to minimize latency.

AI and analytics services may operate as auxiliary components connected to the control server, performing tasks such as mood classification, hashtag generation, or computation of engagement and influence metrics, as may be described in greater detail below. Geolocation APIs may also integrate with the servers to associate sessions with regions or venues, enabling discovery through “near-me” or event-specific listings.

Generally, all communication among system components may occur over a secure network employing standard Internet protocols. User data, audio streams, and messaging traffic may be encrypted end-to-end using TLS or equivalent cryptographic schemes. Firewalls, access control lists, and intrusion-detection mechanisms safeguard the infrastructure against unauthorized access. The architecture may employ microservices distributed across multiple cloud data centers for resilience and scalability, with load balancing and health monitoring to ensure continuous uptime. Together, the combination of user devices, control servers, streaming servers, and secure network pathways forms a cohesive platform capable of delivering synchronized, socially interactive audio streaming at scale.

From an implementation standpoint, the client application on each user device communicates with both an application control server and a broadcast streaming server, as described in the shared architecture. The control server manages user state, control delegation, and session metadata, while the streaming server delivers the live audio content. Control events such as song changes, voting outcomes, and queue updates are transmitted via WebSocket messages or similar real-time channels to ensure low-latency responsiveness. This architecture ensures that regardless of device or network variance, all listeners experience the same song content with synchronized transitions, and that any control transfers occur smoothly without interruption to playback.

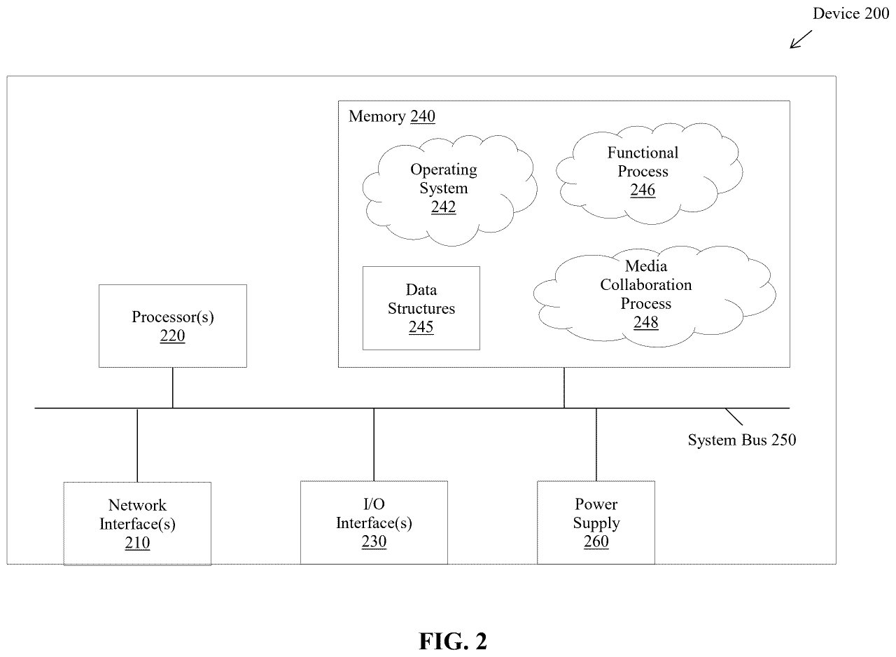

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may be configured as a conventional server computer, workstation, desktop computer, laptop, tablet, smartphone, or other computing device, and can be utilized to execute any of the software components presented herein

The device 200 may comprise one or more of the network interfaces 210 (e.g., wired, wireless, etc.), input/output interfaces (I/O interfaces 230, optionally inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.). Other components not specifically shown, such as a baseboard or “motherboard,” which is a printed circuit board to which a multitude of components or devices can be connected by way of the system bus or other electrical communication paths.

The network interfaces 210 include the mechanical, electrical, and signaling circuitry for communicating data over physical and/or wireless links coupled to the computing system 100. The network interfaces may be configured to transmit and/or receive data using a variety of different communication protocols. The network interfaces may be configured as a network interface card (NIC), such as a gigabit Ethernet adapter, wireless adapter, cellular adapter, optical adapter, or other circuitry capable of connecting the device to other computing devices over a corresponding communication link. It should be appreciated that multiple network interfaces may be present in the device, connecting the computer to other types of networks and remote computer systems.

The I/O interfaces 230 may be configured for receiving and processing input from a number of input devices, such as a keyboard, a mouse, a touchpad, a touch screen, an electronic stylus, a microphone, a camera, or other type of input device. Similarly, I/O interfaces 230 may also provide output, such as to a display, a computer monitor, a digital projector, a printer, a speaker, or other type of output device. Audio interfaces, in particular, may include the mechanical, electrical, and signaling circuitry for transmitting and/or receiving audio signals to and from the physical area in which a device 200 is located. For instance, audio interfaces may include one or more speakers and associated circuitry to generate and transmit soundwaves. Similarly, audio interfaces may include one or more microphones and associated circuitry to capture and process soundwaves. Video interfaces, in particular, may include the mechanical, electrical, and signaling circuitry for displaying and/or capturing video signals. For instance, video interfaces may include one or more display screens. At least one of the display screens may comprise a touch screen, such as a resistive touchscreen, a capacitive touchscreen, an optical touchscreen, or other form of touchscreen display, to allow a user to interact with device 200. In addition, video interfaces may include one or more cameras, allowing device 200 to capture video of a user for transmission to a remote device via network interfaces 210.

The memory 240 comprises a plurality of storage locations that are addressable by the processor(s) 220 and the network interfaces 210 for storing software programs and data structures associated with the implementations described herein. For example, the memory 240 may be a computer-readable storage medium such as a read-only memory (ROM) or non-volatile random access memory (NVRAM), or other suitable memory implementation. The device 200 may also (or alternatively) be connected to a storage device (internal or external) that provides non-volatile storage for the device. The storage device can store an operating system, programs, and data, which may be described in greater detail herein. The storage device can be connected to the device 200 through a storage controller, and may consist of one or more physical storage units. Still further, the device 200 may have access to other computer-readable storage media to store and retrieve information, such as program modules, data structures, or other data. It should be appreciated by those skilled in the art that computer-readable storage media is any available media that provides for the tangible, non-transitory storage of data and that can be accessed by the device 200. By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The processor(s) 220 may comprise elements or logic adapted to execute the software programs and manipulate the data structures 245. In one illustrative configuration, the processor(s) 220 may comprise one or more central processing units (CPUs) which may operate in conjunction with one or more chipsets. The processor(s) 220 may be standard programmable processors that perform arithmetic and logical operations used for the operation of the device 200.

An operating system 242, portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a “media collaboration” process (process 248), as described herein, each of which may alternatively be located within individual network interfaces.

According to one embodiment, the operating system may comprise the iOS® of Apple, Inc., the WINDOWS® operating system, the ANDROID® operating system, or other operating systems and/or variants.

Notably, one or more functional processes 246, when executed by processor(s) 220, cause each device 200 to perform the various functions corresponding to the particular device's purpose and general configuration. For example, a server would be configured to operate as a server, a smartphone would be configured to operate as a smartphone, a database would be configured to operate as a database, and so on. In various implementations, as detailed further below, one or more functional processes 246 and/or specifically the media collaboration process (process 248) may include computer executable instructions that, when executed by processor(s) 220, cause device 200 to perform the techniques described herein.

To do so, in some implementations, one or more functional processes 246 and/or process 248 may utilize machine learning (ML) and/or artificial intelligence (AI). In general, machine learning is concerned with the design and the development of techniques that take as input empirical data (such as network statistics and performance indicators) and recognize complex patterns in these data. Also, artificial intelligence is generally understood to be the simulation of human intelligence in machines, allowing them to perform tasks like learning, problem-solving, and decision-making. This is achieved through algorithms and systems that can perceive their environment, process data, and adapt their behavior to achieve goals, with examples including natural language processing and speech recognition. Forms of ML/AI may also include large language models (LLMs), which are a type of artificial intelligence (AI) that can understand, generate, and work with human language by being trained on vast amounts of text data. LLMs are used for a wide range of tasks, including answering questions, summarizing text, translating languages, writing content, and powering chatbots and virtual assistants. LLMs typically operate by predicting the next word in a sequence, similar to the autocomplete on a smartphone, but at a much more advanced level.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes. Also, it will be appreciated that the device 200 might not include all of the components as shown in FIG. 2, can include other components that are not explicitly shown in FIG. 2, or might utilize an architecture completely different than that shown in FIG. 2.

### Synchronous Social Audio With Dynamic Control Transfer

Traditional music streaming platforms allow users to listen individually or share playlists asynchronously, but they lack mechanisms for real-time communal listening where multiple users can experience the same track simultaneously while interacting socially. Although some services provide limited group sessions or collaborative playlists, these are generally confined to simple play synchronization or shared queue editing without a unified broadcast stream or structured control transfer among participants. There remains a need for a system that merges the immediacy of live broadcasting with the intimacy and interactivity of a small group, enabling users to share music in real time, engage socially, and manage control of the stream in fair, flexible ways.

Moreover, existing systems fail to offer mechanisms for dynamically transferring broadcast authority among participants in a session while maintaining audio continuity. Users are often constrained to a single host or chaotic free-for-all when multiple users attempt to control playback. There is also a lack of meaningful metrics and indicators of engagement during live sessions, such as a collective visualization of how “hot” or popular a broadcast is at any given moment. Furthermore, although location-based features are widely used for discovering nearby users or events, they have not been effectively integrated into shared streaming contexts to facilitate spontaneous participation in localized or thematic listening sessions. The disclosed system herein addresses these deficiencies by providing for synchronized social audio streaming that incorporates real-time broadcast control, dynamic participation models, and adaptive audience interaction feedback.

In one embodiment, the disclosed system allows a user, referred to as a “SynQer”, to initiate a live broadcast stream (referred to as a “SynQ Out”) that delivers synchronized audio playback to other users, referred to as “SynQees”, who join the broadcast session (e.g., “SynQ In”) through a “SynQ Space” or other connection mechanism. The broadcast is implemented through a streaming server that dynamically generates a temporary radio-like channel for each active SynQ Out. Audio files selected by the SynQer are streamed from the server to all connected SynQees via a common streaming URL, such that each listener hears substantially the same content in real time, subject only to minor network-induced delay variations. The SynQer may select songs from their personal playlists, the shared catalog, or a combination thereof, establishing the content and sequence of playback for the session.

In particular, music streaming apps today generally lack interactive, real-time music-sharing capabilities that offer a fully social, immersive experience. Although some platforms allow users to share playlists or synchronize listening with others, these features are often limited in terms of user control, interactivity, and personalization. The SynQing In/Out feature addresses this gap by enabling users (referred to as “SynQers”) to broadcast music to an audience in a “SynQ Space,” allowing others (the “SynQees”) to tune in and experience a synchronized audio stream in real-time. This innovative feature offers users a highly personalized and dynamic experience, where a single user can control music playback, interact with their audience, and even allow input from SynQees in creating a shared musical journey.

In the SynQing In/Out feature, users gain a new level of control over their broadcasting audience. Unlike traditional streaming platforms that function on a subscriber model, SynQing In/Out allows users to toggle broadcasting visibility between a public audience, followers, friends, or even specific individuals. This selective control over who can join a particular broadcast is central to creating intimate, curated listening spaces that can flexibly serve different community or social circles.

In a SynQ Space, SynQers can manage the playback experience by queuing up songs from their own music library or the broader SynQ catalog, giving them the flexibility to tailor the session to their audience's preferences. They can choose to queue songs sequentially or opt to play specific songs immediately, creating a real-time, personalized playlist. In one embodiment, beyond mere queueing of song lists, the techniques herein offer a unique “SynQronization” feature, when a SynQer presses play, pauses, or skips a track, all SynQees experience the action simultaneously, creating a synchronized audio experience that mimics a shared listening environment, as if all users were plugged into the same device.

The feature further supports offline listening, where SynQees can download songs from a SynQ playlist for offline access. This capability allows users to enjoy a curated playlist experience without needing an internet connection, ensuring that the SynQ Space can be enjoyed anywhere, anytime.

Adding a layer of interactivity, SynQees can “pause” their SynQ In session by muting the shared audio stream while allowing the song to continue for other users. When ready, they can rejoin the audio seamlessly, a feature that adds a personalized touch to the real-time listening experience without interrupting the session for others. That is, the system also incorporates an Individual Pause capability, allowing any SynQee to pause playback locally without affecting the global broadcast timeline. When the user resumes, the playback re-synchronizes with the live stream at the current broadcast position, maintaining temporal continuity with the active session rather than resuming from the paused point. This ensures that the shared experience remains cohesive for all participants while still allowing individual flexibility.

Further customization options add unique capabilities, like EQ Copy, which enables SynQees to match their audio equalizer settings to the SynQer's preferences, including headphone profiles where applicable. Another tool, Song Snipping, lets users trim and edit song segments within playlists, providing DJ-style control over playback and adding a new dimension of creativity to the listening experience.

The overall structure and user experience for this feature can be visualized in the following flow: a SynQer initiates a broadcast, selects an audience from options like Public, Friends, or specific individuals, and queues or plays songs. SynQees then join, and while they follow the SynQer's controls (e.g., play, pause, or skip), they also retain certain customization options, such as pause/mute and EQ Copy. The session concludes with a summary of SynQ Minutes, leaderboards, and performance-based badges.

Advantageously, the SynQing In/Out feature brings an entirely new level of interactivity to music streaming, transforming passive listening into an active, social experience. By allowing users to engage with both the broadcaster and other listeners, the feature makes streaming feel like a community activity. According to one or more embodiments herein, the this music-sharing method enables a first user, known as the SynQer, or a set of SynQers, to broadcast audio content to one or more users, referred to as SynQees, within a designated SynQ Space, according to a curated set list (queue of songs/media). Through this feature, the SynQer(s) can control the audio experience in real-time, with all actions executed by the SynQer(s) (such as play, pause, or skip) reflected simultaneously across all SynQees'audio streams. Also, the audience-selection mechanism within SynQing In/Out provides the SynQer with the ability to toggle between different broadcasting settings (e.g., public, followers, friends, or specific users) adding a unique layer of selectivity and control over who may receive the broadcast.

In various embodiments, the invention provides a novel interactive environment referred to as a “SynQ Space.” A SynQ Space represents a dynamic, persistent digital room that unifies social interaction, media control, and synchronized streaming functionality within a single collaborative interface. Each SynQ Space is hosted and managed by a control server that coordinates playback synchronization, membership permissions, and message flow among user devices. The corresponding streaming server delivers the synchronized audio stream, while the control server handles event state, chat messages, engagement metrics, and broadcast authority transitions. Together, these components establish a social broadcasting ecosystem that bridges conventional messaging systems and real-time audio control frameworks.

The SynQ Space interface allows users to discover, create, and participate in broadcast-enabled chat rooms where media playback and conversation occur concurrently. Upon entering the SynQ Space view, users are presented with a list of available rooms that they have joined or that are publicly accessible based on their user plan or permissions. Each entry in the list includes identifiers such as the space name, most recent message preview, participant count, and connection indicators, enabling participants to identify active or trending spaces. A refresh command triggers real-time updates from the control server to ensure the displayed room states reflect current engagement activity. Selecting a space entry transitions the user into an active chat and playback session, where messages, playback events, and controls are streamed in real time.

Within an active SynQ Space, the interface enables the seamless coexistence of music streaming and social discussion. The chat component supports layered conversation structures, displaying participant profile images, timestamps, and real-time status indicators synchronized through the control server. A “sync indicator” visually represents whether live playback synchronization is active, allowing users to identify when the host or another participant is broadcasting. During synchronized sessions, user devices receive real-time playback state updates that align their audio with the broadcast controller's timeline within a bounded synchronization threshold, ensuring consistent playback across devices regardless of network variations.

The system further introduces inventive methods for creating and managing SynQ Spaces. A user can initiate a new space using an integrated control pane accessible from the primary interface. The creation workflow allows configuration of key metadata including group name, description, image, and join permissions. For example, a user can enable or disable a “scan-to-join” option, which automatically generates a machine-readable QR code tied to a unique session identifier within the control server's registry. When another user scans the code using their device, the application verifies space availability and authentication tokens, and upon validation, seamlessly adds that user to the appropriate SynQ Space. This mechanism enables real-world onboarding of new members without requiring manual invitation links, expanding the notion of spontaneous, location-anchored digital gathering.

Once a SynQ Space is created, the host can invite participants by searching among friends or followers or by scanning QR codes associated with other spaces. The interface displays each contact's image and status to facilitate quick selection. The control server validates invitation limits based on the user's subscription tier and displays contextual messages if creation or membership thresholds are reached. Before finalizing, a preview screen provides an opportunity to review space parameters and member lists, ensuring that all configuration options (e.g., access level, visibility, and synchronization permissions) are confirmed before activation.

A distinctive aspect of the SynQ Space system is its integration of SynQ In and SynQ Out functionalities. SynQ Out allows a user to act as a broadcaster, selecting audio tracks or playlists and transmitting them in real time to designated recipients, including individual users, friend groups, or public audiences. Listeners participating via SynQ In join these sessions as synchronized recipients, hearing the same song sequence with tightly aligned playback. Unlike conventional streaming platforms that provide only independent listening experiences, this synchronized broadcast paradigm enables shared music sessions controlled by user-defined rules.

The system herein further includes intelligent audience targeting and control granularity. Before initiating a broadcast, a user selects the intended visibility scope, such as “Public,” “Friends,” or “Followers”, and may associate one or more hashtags to contextualize the broadcast theme or mood. These hashtags become searchable indices across the platform, allowing other users to discover live or recorded sessions based on shared interests. During playback, the broadcaster retains control of the media queue, but control can be dynamically passed to another participant based on system policies (e.g., administrator assignment, open queue, or voting-based delegation).

Within the SynQ Out player interface, the broadcaster can view metadata such as song title, artist, playback duration, and listener engagement metrics. Listeners can interact socially by reacting to songs, adding comments, or tagging other users and songs using symbolic prefixes (“@” for mentions, “#” for tags, and “*” for songs). These symbolic mentions are parsed by the application and linked to relevant entities in the underlying database, enhancing the interconnectivity of social interactions and media content.

The system also supports shareable broadcast links generated through a dynamic linking service. When a broadcaster shares a SynQ Out session, the system produces a persistent URL or QR code embedded with metadata describing the current broadcast state. Recipients of the link are directed into the appropriate SynQ Space and automatically aligned with the broadcast stream, reducing friction in discovery and participation.

Together, these mechanisms establish an inventive framework for synchronized, socialized streaming control. Unlike conventional chat or media applications that operate independently, SynQ Spaces create an integrated environment where community, control, and content coexist. The convergence of synchronized media, multi-user control logic, dynamic onboarding, and semantic tagging represents a technical advancement that transforms passive music consumption into an interactive and participatory broadcast ecosystem.

According to one or more embodiments of the present disclosure, the system supports several operational modes that govern control of the broadcast stream. In particular, the experience of sharing music in social settings often involves passing control from one person to another, with each individual curating the playlist for a time before handing it off. Traditional music streaming platforms, however, lack this dynamic control transfer, often limiting the session to a single host or allowing chaotic, unstructured access for all listeners. This restriction can prevent a truly social and collaborative listening experience. The “Pass the Aux” feature in SynQ Spaces introduces a new approach, enabling structured, temporary control transfers within a broadcast, allowing users to take turns and contribute actively to the listening session.

The Pass the Aux feature empowers users to share control within a SynQ Space by letting the SynQer transfer music broadcasting capabilities to another user. This functionality creates a smooth handoff of music playback rights, enabling users to take turns selecting and playing songs for everyone in the session. Unlike conventional platforms where either one person controls the session or everyone has equal access (which can lead to disorganized playback), Pass the Aux provides a structured transfer process, where control remains with one designated individual at a time.

In “Open Aux Mode”, any user in the SynQ Space can contribute tracks to the broadcast queue from their own playlists. The system may maintain a first-come-first-served queue, or, preferably, a round-robin order in which songs are drawn sequentially from each active participant's queue. For example, if users A, B, and C are connected, playback may proceed by alternately selecting one song from each user's list (A1, B1,C1, A2, B2, C2, and so on). If a participant's queue becomes empty, the system skips to the next user automatically, ensuring uninterrupted playback. As participants join or leave the SynQ Space, the round-robin sequence dynamically reconfigures in real time.

In “Admin Aux Mode”, an authorized user (typically the creator or designated administrator of the SynQ Space) maintains exclusive control over broadcast permissions. The administrator may manually select which users are permitted to contribute songs, temporarily assign or revoke control, and determine the ordering logic among contributors. This mode provides a more curated experience suitable for structured events or live shows where control must remain consistent.

In “demAUXracy Mode”, or more simply, “Democracy Mode”, control of the broadcast is determined through audience voting. When one or more users request to take the “aux,” the system initiates a timed voting window during which all listeners may cast votes to select the next controller. For instance, three users may submit requests within a two-minute interval, followed by a one-minute vote collection phase. The user receiving the majority vote is granted broadcast control for the next designated period or until another voting cycle occurs. The system may include tie-breaking logic, such as prioritizing earlier requestors or those who have not recently held control, to maintain fairness and engagement. Additional rules may be configured, such as requiring that a requestor must have participated in the session for a minimum number of songs before being eligible to request control, thereby preventing transient or malicious participation.

Hybrid modes may also exist, such as demAUXracy Mode resulting in a plurality of aux controllers, which may then be managed in a round robin style similar to Open Aux, just with the limited number of controllers. As another example, an Admin Mode administrator may put the next controller(s) up to a vote of the listeners.

To request control, generally in embodiments other than Open Aux (unless restricted to a set number of users), a user within the SynQ Space can ask to “take the Aux,” at which point the SynQer can activate a poll that prompts the audience to vote on whether to grant the requester control, or to compete against other users for control that have also requested the Aux. If the poll yields a “win” (e.g., a majority) in favor of approval, the user requesting the Aux gains control, allowing them to broadcast their selected tracks to the entire group (in real-time or by controlling the upcoming song queue, accordingly). This feature mimics the social experience of passing an Aux cord among friends, introducing a natural, real-world dynamic into the digital space and fostering an environment of shared discovery and collaboration.

The structured transfer is managed in real time, ensuring seamless transitions between users without disrupting the playback experience for the listeners. For instance, when control shifts from one user to another, the song currently playing will continue uninterrupted until the new Aux-holder selects the next track. Additionally, users can request control again after a designated time limit or based on specific session rules, preventing any single user from monopolizing the session and encouraging fair participation.

Through Pass the Aux, the feature also facilitates diverse musical contributions within the same session, allowing users to explore multiple genres, styles, or moods in a single stream. This dynamic enhances the social experience and allows SynQees to feel more involved in the broadcast, as they contribute directly to the shared listening experience. Overall, the Pass the Aux feature elevates the digital music-sharing experience by creating an atmosphere that closely resembles in-person social interactions, with each user having the opportunity to shape the playlist collaboratively.

Advantageously, the Pass the Aux feature creates an authentic social experience by allowing users to take turns controlling the music in a structured, organized manner, which mirrors the real-world practice of passing an Aux cord. By introducing a voting process, it ensures that the listening experience remains cohesive and enjoyable, with control transfers happening only with audience approval. This feature brings a collaborative, community-oriented element to SynQ, enabling users to experience diverse musical selections while retaining control over the session's flow. The structured handoff and timed request options prevent any one user from dominating the session, fostering a fair, inclusive environment that enhances engagement and social interaction. Through Pass the Aux, SynQ bridges digital streaming with real-world social dynamics, creating a unique, memorable experience for all participants.

According to one or more embodiments of the present disclosure, the system also supports an integrated “VibeCheQ” subsystem that monitors audience interaction to generate visual indicators of engagement and enjoyment. The system aggregates inputs such as likes, emojis, comment frequency, and other real-time interactions, computing a composite engagement score that reflects the collective energy of the session. The broadcast interface may visually change in response to the VibeCheQ level, such as, for example, intensifying color saturation or displaying animated icons to indicate high energy or popularity, or adding certain sessions to recommended lists for listeners to join. Sessions exhibiting strong engagement may be highlighted within discovery lists as “hot SynQs,” encouraging new users to join. Conversely, sessions with low activity may appear desaturated or lower in ranking, providing an organic feedback loop that visually communicates session dynamics.

In particular, music streaming platforms primarily provide passive interactions, offering limited ways for listeners to give real-time feedback on a session's quality. While simple “like” or “dislike” features exist, they fall short of capturing ongoing audience sentiment and engagement during a live music stream. The VibeCheQ feature in SynQ Spaces addresses this gap by allowing users to continuously rate the quality of a SynQ Out session, creating a dynamic and visually engaging experience that reflects the collective mood. This feature provides instant feedback to the SynQer and allows SynQees to influence the session's atmosphere, fostering a more responsive and interactive environment where the mood is shaped by audience reactions.

VibeCheQ introduces a gamified element to the SynQ Space by allowing SynQees to vote on the session's quality. Users can upvote or downvote based on consecutive good or poor songs, influencing the screen's saturation and visual aesthetics. This feature provides immediate feedback to the SynQer, creating a responsive and interactive environment. Vibe CheQ enhances user engagement and satisfaction by encouraging positive song selections and dynamic playlists. It sets the app apart by incorporating real-time audience reactions, making the music streaming experience more visually and emotionally engaging.

That is, the VibeCheQ feature introduces a real-time rating system where SynQees can upvote or downvote the vibe of a SynQ Out session based on the current song or the overall playlist. As listeners cast their votes, the cumulative ratings are reflected through visual changes on the SynQer's screen, providing immediate feedback on how the session is resonating with the audience. For example, if consecutive songs receive high ratings, the screen's colors may become more saturated, with vibrant purples and blues symbolizing an energized, positive vibe. Conversely, a series of downvotes may cause the colors to fade into black-and-white or muted tones, indicating a low-energy session or a disconnect with the audience's preferences.

In addition to simple up/down-votes, the techniques herein may also utilize other factors in the VibeCheQ, such as number or rate of comments, number or rate of joins of SynQees, number of shares, or any other measurable or assumed level of engagement of the listeners. For instance, in one embodiment, the techniques herein may use AI to interpret actual conversations within a SynQ Space (chats, shares, etc.) to take valuable insight to what people are saying about the session and/or songs, like understanding the positive feelings of “this space is hype!” or “fire fire fire!” versus the negativity implied with comments such as “this song is totally wrong for this space” or “ugh, killing the vibe! Boo!” (or, simply, the rate of positive comments, or any comments at all, slowing down considerably, etc.).

This continuous feedback system gives the SynQer valuable insights into what resonates with their listeners, allowing them to adjust the playlist to improve audience engagement. The Vibe CheQ feature also tracks engagement through comments, likes, and interactions, considering these metrics in the vibe calculation. As activity in the SynQ Space increases, the session's vibe visual intensifies, showing that the broadcast is gaining momentum and that the audience is actively engaged.

In addition to immediate visual cues, VibeCheQ can also influence the session ranking within SynQ Spaces. Sessions with consistently high vibes are promoted within the app, appearing as popular SynQ Outs that other users might want to join. This gamified approach encourages SynQers to select crowd-pleasing songs and craft dynamic playlists that maintain a high energy level, as they are rewarded with increased visibility and potential new listeners.

By updating the vibe rating with each new song, VibeCheQ moves beyond the static “like” model found in traditional social media and streaming apps. This ongoing rating feature captures real-time audience sentiment, allowing users to influence the mood of the session actively and create a collaborative listening experience. The feature ultimately transforms passive listening into an interactive event where both the SynQer and SynQees contribute to the session's atmosphere and energy.

Advantageously, the VibeCheQ feature enhances interactivity by allowing SynQees to actively shape the atmosphere of a live session, moving beyond simple “like” functions to create an immersive, mood-responsive experience. By providing real-time visual feedback, Vibe CheQ allows the SynQer to understand audience sentiment and adjust the session accordingly, fostering a stronger connection with listeners. The engagement-driven vibe calculations and session ranking offer a gamified experience that incentivizes high-quality, crowd-pleasing playlists, rewarding SynQers with increased visibility and popularity within the app. Through this feature, SynQ transforms passive listening into a dynamic, collaborative experience where audience feedback drives the mood and energy, enhancing both user engagement and enjoyment.

According to one or more additional embodiments of the present disclosure, the system also supports location-awareness to further enhance user discovery and participation. The application allows users to browse or filter active broadcasts by proximity, using geolocation tags associated with each SynQ Out, or based on physical proximity detection. A user entering a venue such as a gym, park, or campus may view nearby live sessions and join immediately. The system may also allow hosts to tag their sessions with general locations or events, enabling collective listening experiences tied to local communities or occasions (e.g., selecting such location tags as “Boston” versus “Los Angeles” or “OSU Tailgate” versus “StrongArm Gym San Francisco” or “Newport Cool-Coffee-Café”). This contextual linkage transforms passive streaming into a location-anchored social experience.

That is, Location SynQ is a feature that allows users to synchronize their SynQ experience with others based on selected locations (whether the user is within that location or simply wants to join a session that is sourced from a specific location), or that are specifically within a certain distance. This feature adds a geospatial element to the app, enabling users to connect with nearby (or locale-based) individuals who share similar music preferences. It transforms the music streaming experience into a social and local event, fostering connections between users based on their physical proximity. This unique feature goes beyond the typical global reach of music streaming apps, creating a more localized and community-driven platform.

While music streaming is typically a remote and solitary experience, many social experiences are enhanced by proximity-based interactions, where people share moments in real-time and physical space. Current streaming platforms lack the ability to connect users based on geographic location or proximity, missing an opportunity to foster real-world interactions through music. The Location/Proximity-Based SynQ feature bridges this gap by allowing users to connect with others in nearby locations, creating a music experience that transcends the digital realm and enhances social engagement in physical spaces. This feature is designed to foster real-world connections among users who share similar music preferences, transforming streaming into a shared experience within specific venues, events, or social settings.

The Location/Proximity-Based SynQ feature empowers users to SynQ In/Out with others within a specified distance or within a tagged location, creating a spatial element to music discovery and interaction. For instance, users walking into a gym, café, or park can join a nearby SynQ Space, synchronizing their music experience with others in the area. This capability allows for shared music experiences based on geographic proximity, enhancing the sense of community and creating spontaneous connections through music. The feature not only supports casual music sharing but also provides opportunities for users to engage with local culture and discover music in a way that reflects their environment.

One unique implementation of this feature is a SynQ Live Concert, where users at events can connect to a silent disco-style experience, tuning into multiple SynQers broadcasting to a private group. This setup enables attendees to listen to live feeds from various DJs or performers within the same venue, offering a personalized experience within a shared environment. Whether users prefer an upbeat set or a chill mix, they can easily switch between broadcasts, catering their music experience to their preferences while remaining part of the communal event.

The feature also includes NFC-based SynQ Spaces, where users can tap their phones together to create a shared SynQ session. Imagine students in a library or friends at a silent disco who want to sync their music; with NFC, they can create an exclusive SynQ Space just for their group. Users also have the option to join via QR codes, adding flexibility for quickly forming SynQ Spaces that connect users within the same vicinity. This technology enables groups to come together spontaneously, adding a digital layer to real-world interactions and allowing for a unique blend of music sharing and social engagement.

With Location/Proximity-Based SynQ, users gain the ability to explore SynQ Spaces that reflect their immediate surroundings (or chosen locations from afar), promoting a sense of presence and encouraging connections with people in close proximity. By merging digital streaming with physical spaces, this feature turns any location into a potential music-sharing hub, making music streaming a more social, place-based experience.

Advantageously, the Location/Proximity-Based SynQ feature enhances the social element of music streaming by allowing users to synchronize their music experience with others in their immediate vicinity or within a particular location as desired. This proximity-based (or location-based) approach transforms digital streaming into a shared, interactive experience rooted in real-world environments. By blending digital and physical music-sharing, this feature enriches user engagement, making music streaming more adaptable, interactive, and grounded in the real world.

Other features may also be included within the innovative synchronous audio social platform. For instance, in social media, users often communicate with multimedia elements like images, videos, and GIFs to express thoughts or reactions. However, traditional music streaming platforms typically limit user interactions to static playlists or text-based comments, missing an opportunity to blend audio with visual elements that enrich expression. A “Music Snippet Post with Comment/GIF” feature in SynQ Spaces allows users to create short audio clips from songs and share them with text, images, videos, or GIFs, introducing a new, expressive way to interact with music on a social platform. This feature merges music with multimedia, offering users a creative outlet to share snippets of songs in ways that capture mood, personality, and context more vividly. The Music Snippet Post with Comment/GIF feature empowers users to extract short clips, or snippets, from songs and post them directly within their SynQ Space. Rather than sharing entire songs or playlists, users can select key moments or favorite parts of a track (such as a catchy chorus or memorable lyric) and pair these snippets with a personal message, image, video, or GIF. This combination transforms music sharing into a multimedia storytelling experience, where each snippet reflects not only the user's musical taste but also a visual or textual narrative that adds context and emotion to the clip.

To create a snippet post, users can open the audio player, select a specific segment of a song, and then add a comment or multimedia element. For example, a user might capture a 15-second snippet of an upbeat song and pair it with a GIF of friends dancing, conveying a lively mood that invites others to engage or react. This feature allows users to communicate their emotions or experiences in a way that resonates more deeply with listeners, making the music-sharing experience more personal and relatable. The snippets can be shared on timelines, profiles, or within group chats, creating a dynamic feed where users discover new songs or see favorite tracks presented in fresh, unique ways. This snippet-based sharing format aligns well with modern social media consumption, where users often prefer shorter, engaging content that they can quickly explore and react to. Additionally, snippets with high engagement may gain visibility on popular feeds within the SynQ app, encouraging users to craft creative, high-quality posts that resonate with the community.

By integrating audio snippets with multimedia comments, the feature also provides artists and creators a platform to showcase their music in bite-sized, interactive posts. Fans can take favorite parts of a song, pair them with a GIF or reaction, and share them widely, generating buzz around the track. This format not only promotes discoverability but also adds a layer of personalization and creativity to music sharing that amplifies the artist's reach within the social community.

Another additional feature according to one of more embodiments herein may be a “Polling” feature adds an interactive element to the SynQ Space, allowing the SynQer to engage with the audience in real-time. Users can vote on various issues, including Next Song Suggestions, Pass the Aux recipients, or conversation starters. This feature empowers the audience, providing them with a voice in shaping the SynQ experience. By incorporating polling, the app transcends the traditional one-way streaming model, turning it into a collaborative and participatory platform that adapts to the preferences of the community.

In traditional music streaming platforms, the user experience is largely passive, with minimal opportunities for interaction or feedback during live broadcasts. While listeners may be able to like songs or leave comments, they typically have no say in shaping the direction of the music stream itself. This lack of interactivity can lead to a one-dimensional experience that limits user engagement. The Polling feature in SynQ Spaces addresses this gap by giving listeners an active role in influencing the content of a SynQ session. By integrating polling functionality directly into the music-streaming experience, SynQ enables users to participate in real-time decisions, such as voting on the next song or selecting conversation topics, creating a collaborative and adaptive listening environment.

The Polling feature introduces a layer of interactivity to the SynQ experience, empowering SynQees to influence what happens next within a SynQ Space. With this feature, a SynQer can activate polls during a live session, allowing participants to vote on options such as the next song to be played, or even who should take control of the “Aux,” thereby curating the experience according to group preferences. For instance, during a session, the SynQer may open a poll for “Next Song Suggestion,” enabling the audience to vote from a list of choices or make specific song requests. As users cast their votes, the SynQer can make real-time adjustments to the playlist, ensuring that the music reflects the mood and interests of the listeners.

Additionally, the Pass the Aux feature can integrate with polling, where users can request control of the broadcast, and a poll will open for the audience to vote on whether the requesting user should be granted the Aux. If over 50% of participants agree, the user gains temporary control, allowing them to select and play songs for everyone in the SynQ Space. This feature mimics the social experience of a group gathering, where friends share and take turns controlling the music, adding a dynamic social component to the digital listening experience.

SynQ Polling also supports more complex audience insights through AI-driven interpretation of user preferences. For example, if the audience votes consistently for high-energy songs, the AI could detect this trend and adjust the suggested options to better match the group's mood, such as offering only upbeat or genre-specific choices. This AI-driven functionality ensures that the session remains responsive to the audience's evolving preferences, delivering a curated yet adaptive experience.

The Polling feature further extends to Voting Ads, which present interactive advertisements within the timeline. These ads can be configured to collect audience feedback through voting, providing advertisers with valuable data about user preferences and enhancing engagement by inviting users to interact directly with the brand. This aspect not only benefits advertisers but also keeps the user experience interactive and engaging, even during ad breaks.

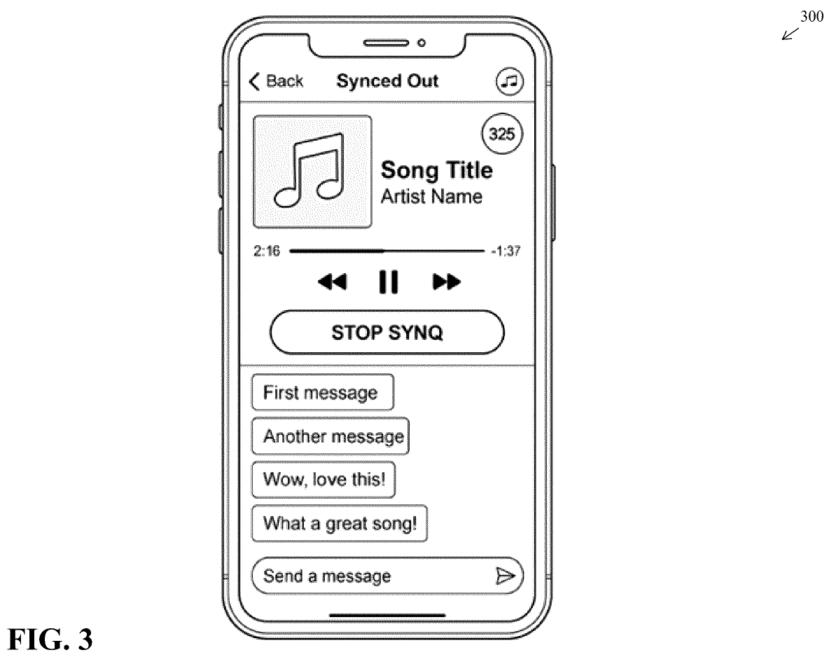

FIG. 3 illustrates an example user interface (user interface 300) for an embodiment of the inventive social synchronization and media control system. As shown, the interface is rendered on a user device such as a smartphone or tablet, and provides an integrated view for synchronized playback, messaging, and session control within a SynQ broadcast or shared listening experience.

The display includes a playback region at the top, which presents metadata associated with the currently playing song. This metadata includes a graphical song representation or artwork thumbnail, a song title, and an artist name. A playback progress indicator is positioned below the metadata and dynamically reflects the elapsed and remaining time for the track, enabling visual feedback of the synchronized playback state across connected devices. Playback control icons are provided adjacent to the progress bar, allowing authorized users to initiate play, pause, skip, or reverse commands within the shared session.

A SynQ control element, currently labeled “STOP SYNQ,” is prominently positioned below the playback controls. This element enables a broadcasting user to terminate or pause the synchronization of playback across one or more remote devices participating in the active SynQ session. The button may also signal the control server to broadcast a state update to all listening clients, ensuring that their playback streams are simultaneously halted or transitioned into a waiting state to maintain temporal alignment.

Beneath the playback section, a real-time messaging panel is displayed, showing chat messages exchanged among participants in the active SynQ session. Each message may be rendered within a discrete bubble element, maintaining chronological order from top to bottom. This layout enables conversational interaction that complements the shared media experience. Messages may include comments, reactions, or symbolic tags (e.g., “@user,” “#tag,” or “*song”) that are parsed by the system for association with corresponding entities in the tagging and search index described elsewhere in this disclosure.

A text input field labeled “Send a message” is positioned at the bottom of the interface, allowing users to compose and transmit new messages to the group in real time. Messages entered through this input are communicated to the control server, which propagates them to other participants via synchronized messaging streams. The interface may include an adjacent send icon, which, when activated, transmits the user's input to all active session members and updates the conversation feed.

Collectively, the interface illustrated in FIG. 3 demonstrates at a high-level how the app herein merges synchronized media control with real-time social interaction within a single unified display. Unlike traditional streaming players that isolate playback from communication, this interface establishes a bidirectional link between playback events and social messaging activity. Through this integration, users experience a shared auditory environment enriched by live conversation, fostering connection and engagement synchronized to the rhythm of the music itself. Notably, while a certain configuration of the user interface 300 is shown, other suitable configurations may be used with the inventive app herein, and the view shown is merely one example display for the purpose of discussion herein.

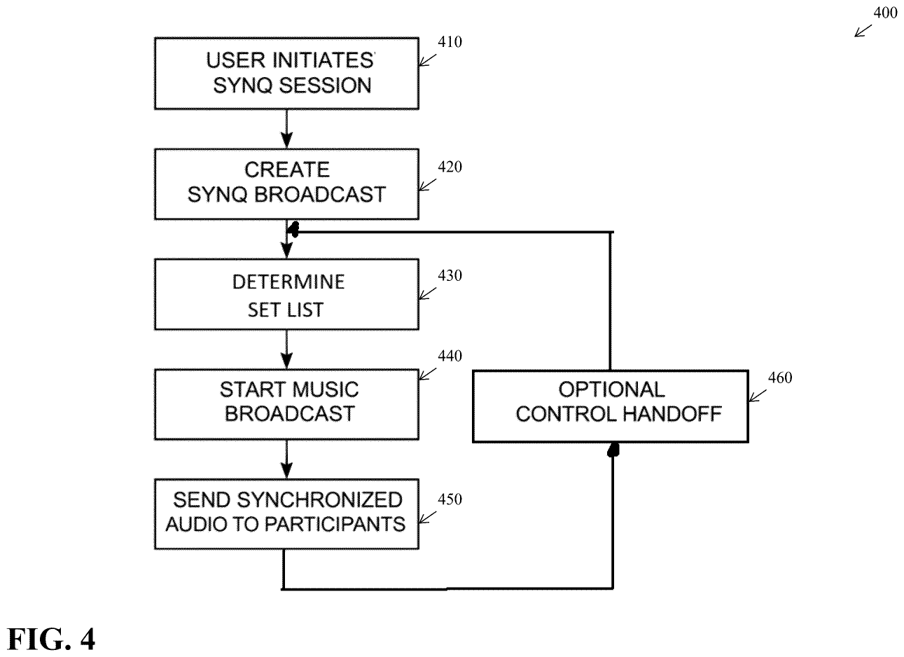

FIG. 4 shows a representative flow of operations 400 for initiating and synchronizing a broadcast session. The process begins in step 410 when a user selects a “Sync Out” command within the application (“user initiates a SynQ session”), prompting the control server in step 420 to create a unique streaming channel and corresponding metadata entry (“create SynQ Broadcast”). The host's selected track list may then be uploaded (all at once, over time, etc.) or referenced by the streaming server in step 430 (“determine set list”), which begins distribution of the first song in step 440 (“start music broadcast”), with the synchronized audio sent to (i.e., received by) select participants in step 450 (“send synchronized audio to participants”). Note that while the session continues, the set list may be extended/updated, and as shown in step 460, control of the set list may be changed to other authorized users as described herein (“optional control handoff”). The flow concludes whenever playback the session ends, ensuring clean termination of the broadcast and archival of listening metrics.

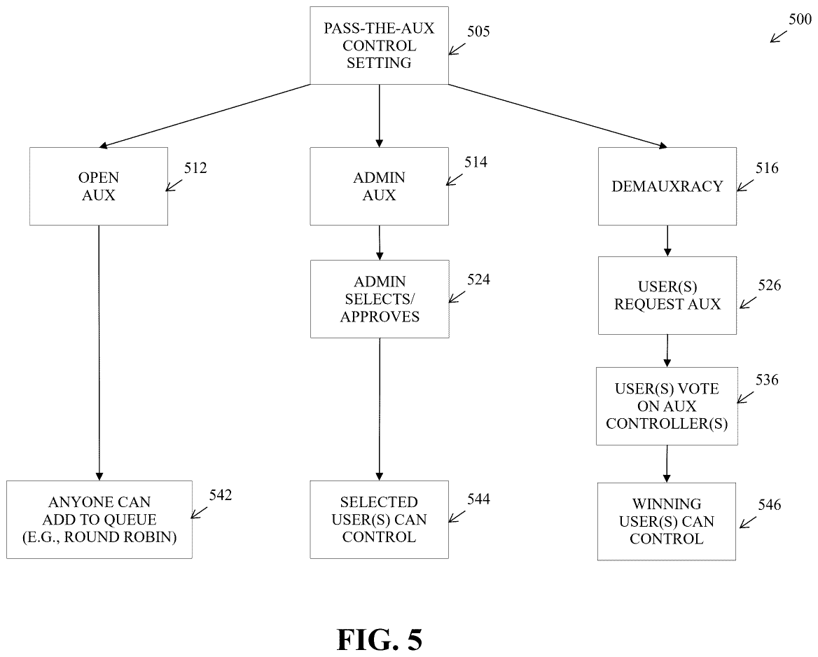

FIG. 5 illustrates logic 500 governing transfer of playback authority among participants. Three operational modes are shown: Open Aux, Admin Aux, and demAUXracy. As shown, a Pass-the-Aux control setting 505 may determine whether the control is Open Aux 512, Admin Aux 514, or demAUXracy 516. In Open Aux mode, the control server automatically cycles track selection among participants in a round-robin queue based on each user's playlist, i.e., anyone can add to the queue (control logic 542). Admin Aux mode enables a designated administrator to assign or revoke control manually (“admin selects/approves” 524), limiting additions to approved users that can control (control logic 544, selected user(s) can control). The demAUXracy mode introduces a voting mechanism where participants request control (block 526) and peers vote (block 536) to determine the next controller(s) (control logic 546, winning user(s) can control). The diagram highlights how these modes share a common decision framework yet differ in how authority transitions occur, allowing adaptable control dynamics across social contexts. Note that the setting for which mode is in use (Pass-the-Aux control setting 505) can change mid-session, and hybrid modes may also be configured (not explicitly shown for clarity).

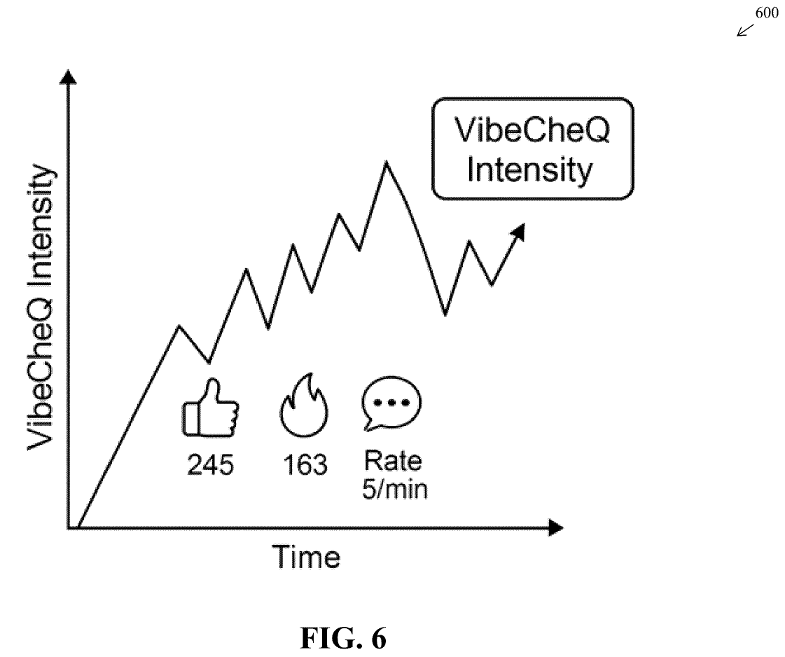

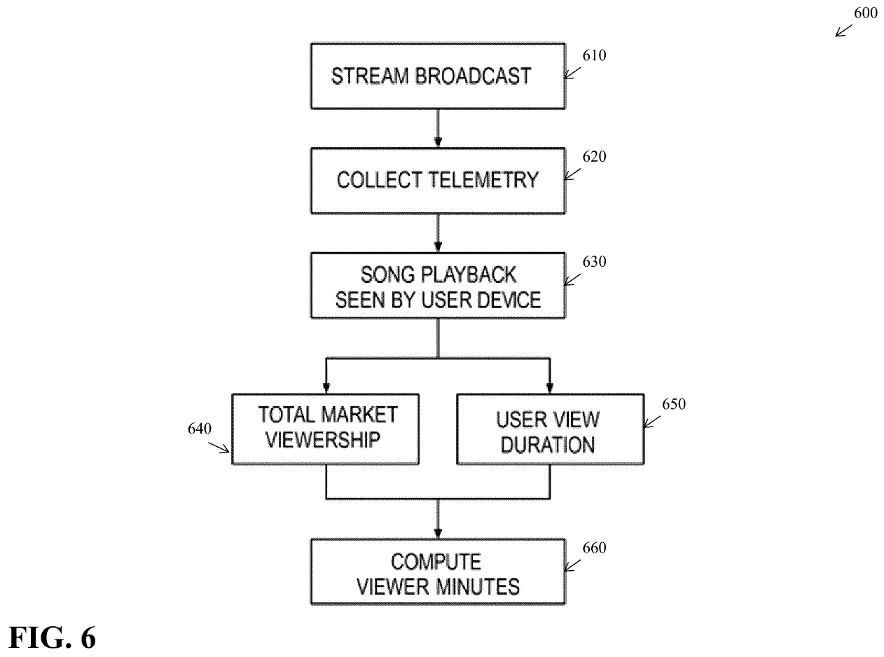

FIG. 6 depicts an example engagement visualization (interface 600) referred to as VibeCheQ. Listener devices transmit reaction data, such as likes, emoji responses, and comment frequency, to the control server, which aggregates the information into a composite engagement score. The resulting measure may be relayed back to all participants and displayed through dynamic indicators such as color changes, animated icons, or progress bars representing audience energy on the app itself. Various thresholds in terms of absolute values (e.g., intensity over/under a given threshold), or else in terms of rates of change (e.g., intensity rapidly increasing or decreasing), and so on may be used to translate this information into different levels of “VibeCheQ” indicators, such as hot/not, ok/good/great, etc. The visualization updates continuously during playback, allowing users to perceive collective enthusiasm in real time. This feedback loop encourages participation and offers hosts insight into audience response without interrupting the listening experience.

The disclosed system provides a comprehensive framework for real-time, socially connected music streaming that bridges the gap between isolated listening and live shared experiences. By combining synchronous playback with dynamic control-transfer models, the invention creates an environment where participants can interact, contribute, and influence the direction of a musical session in a structured yet flexible manner. The Open Aux mechanism introduces a round-robin scheduling method that ensures equal opportunity for contribution while maintaining uninterrupted playback. The Admin Aux and demAUXracy modes introduce governance and crowd-driven fairness, allowing session creators or listeners to determine control dynamically without disrupting the broadcast.

Unlike conventional collaborative playlists, the invention maintains a real-time broadcast stream that aligns playback across multiple devices using a common streaming source. This architecture eliminates timing inconsistencies while preserving the spontaneity of live listening. The inclusion of the Individual Pause feature maintains the cohesion of the group session while providing personalized control over playback, which is something lacking in typical broadcast systems.

The VibeCheQ subsystem further enhances engagement by transforming passive metrics into a living, visual representation of session energy, offering instant feedback that reflects listener sentiment. This not only improves user satisfaction but also fuels organic discovery, as highly active sessions naturally rise in prominence through visual cues and rankings. The integration of location-aware discovery allows users to connect with nearby sessions or communities, bridging digital and physical experiences.

From a technical standpoint, the invention efficiently leverages real-time communication protocols, dynamic queue management, and distributed streaming architecture to deliver low-latency synchronization and adaptive scalability. Collectively, these features establish a social listening framework that is richer, more interactive, and technically more robust than existing systems.

In some implementations, an illustrative method herein for synchronized social audio streaming among a plurality of user devices may comprise: receiving, at a control server, a request from a first user device to initiate a live audio broadcast session; creating, by the control server, a particular broadcast session in response to the request, including causing a streaming server to generate a corresponding streaming channel for the particular broadcast session; receiving, at the control server, a playlist of one or more audio tracks selected by a controlling device for the particular broadcast session as determined by broadcast control settings for the particular broadcast session; and instructing, by the control server, the streaming server to transmit audio data of a currently playing track of the playlist to a plurality of listener devices such that playback of the audio data occurs substantially synchronously across the plurality of listener devices.

In one embodiment, the control server further receives, from the controlling device, a selection of a particular audience visibility scope for the particular broadcast session, the particular audience visibility scope comprising one of a public audience, a friends-only audience, a followers-only audience, or a private invitation-based audience.

In one embodiment, the method further comprises: receiving, from the controlling device, a command to transfer broadcast control to a second user device participating in the particular broadcast session, wherein the control server authenticates the second user device and designates the second user device as the controlling device for subsequent audio transmissions.

In one embodiment, the method further comprises: receiving, from one or more requesting devices participating in the particular broadcast session, a request to transfer broadcast control to the one or more requesting devices; managing a voting process within the particular broadcast session among the plurality of listener devices regarding the request to determine a new controlling device from among the one or more requesting devices; and designating the new controlling device for subsequent audio transmissions according to an outcome of the voting process.

In one embodiment, each of the plurality of listener devices is a corresponding controlling device, the method further comprising: accepting additions to the playlist for subsequent audio transmissions based on one of either a first-come-basis or a round-robin basis from any of the plurality of listener devices.

In one embodiment, the controlling device is the first user device.

In one embodiment, the method further comprises: receiving, from one or more listener devices, engagement input data associated with the currently playing track, the engagement input data comprising at least one of comment text, emoji reaction, or hashtag tag; and storing the engagement input data in association with the particular broadcast session.

In one embodiment, the control server generates real-time engagement metrics for the particular broadcast session based on aggregated listener interactions, and causes visual indicators of the real-time engagement metrics to be displayed at the controlling device and the plurality of listener devices.

In one embodiment, the method further comprises: presenting a list of current broadcast sessions to a plurality of user devices.

In one embodiment, the method further comprises: managing user commentary from the plurality of listener devices within a commentary portion of an associated social audio streaming application on the plurality of listener devices.

In one embodiment, the corresponding streaming channel is accessible through a corresponding uniform resource locator (URL) accessed by an associated social audio streaming application on the plurality of listener devices.

Note that an illustrative flowchart outlining a procedure (method) in accordance with the method steps described above is effectively contemplated herein, accordingly.

In still other implementations, an illustrative apparatus herein may comprise: one or more network interfaces to communicate with a network; a processor coupled to the one or more network interfaces and configured to execute one or more processes; and a memory configured to store a process that is executable by the processor, the process comprising: receiving a request from a first user device to initiate a live audio broadcast session; creating a particular broadcast session in response to the request, including causing a streaming server to generate a corresponding streaming channel for the particular broadcast session; receiving a playlist of one or more audio tracks selected by a controlling device for the particular broadcast session as determined by broadcast control settings for the particular broadcast session; and instructing the streaming server to transmit audio data of a currently playing track of the playlist to a plurality of listener devices such that playback of the audio data occurs substantially synchronously across the plurality of listener devices.

In still other implementations, a tangible, non-transitory computer-readable medium may store computer-executable instructions that, when executed by one or more processors, cause a device to perform operations comprising: receiving a request from a first user device to initiate a live audio broadcast session; creating a particular broadcast session in response to the request, including causing a streaming server to generate a corresponding streaming channel for the particular broadcast session; receiving a playlist of one or more audio tracks selected by a controlling device for the particular broadcast session as determined by broadcast control settings for the particular broadcast session; and instructing the streaming server to transmit audio data of a currently playing track of the playlist to a plurality of listener devices such that playback of the audio data occurs substantially synchronously across the plurality of listener devices.

### Usage-weighted Influence Metrics for Broadcast Streams

While streaming platforms provide general information about plays or listener counts, such metrics are often coarse and fail to capture the nuanced engagement patterns of live, multi-user broadcast environments. Existing systems typically record that a song was played or streamed a certain number of times but do not correlate that data with session context, audience size over time, or the specific conditions of the broadcast in which the play occurred. Moreover, as social streaming systems evolve toward synchronized group sessions, conventional metrics, such as total play count or average listen duration, are insufficient to measure the impact or popularity of a given track in relation to audience dynamics.

There remains a need for a system that continuously and efficiently tracks listening activity during synchronized broadcast sessions, associates that activity with precise playback intervals, and aggregates it into a unified metric that reflects real-time audience participation and influence. Such a system should be capable of deriving meaningful insights, including join and leave rates, engagement slopes, and “area under the curve” computations representing total listening time per song, without imposing significant overhead on user devices or network resources.

In one embodiment, therefore, the disclosed system measures audience engagement within live, synchronized audio broadcast sessions by generating granular playback telemetry at user devices and consolidating that data into server-side metrics known as “SynQ Influence Metrics”. Each user device participating in a broadcast periodically reports a lightweight activity signal to the control server, such as a timestamp, current track identifier, playback state, playlist, play times, etc., at fixed intervals, for example every ten seconds, or other periodic timing, such as based on connectivity, data size, and so forth. The control server aggregates these periodic reports across all devices participating in a given broadcast session to construct a time-series profile representing the number of active listeners as a function of playback time.

For each track in the broadcast, the system may determine the start and end times of playback based on the broadcast sequence and correlates them with the reported activity data. The resulting data points form a “listener-density curve” over time, from which the system computes the integral (or area under the curve) to obtain the total cumulative listening time contributed by all users during the playback of the song, regardless of when individual users joined or left the session.

For example, if a particular song plays for three minutes and the system records 500 concurrent listeners for the first minute, 600 for the second, and 400 for the third, the total minutes listened to a song is computed as the sum of these intervals, i.e., 1,500, 1,800, and 1,200, yielding 4,500 total minutes that the song was listened to by users. (Note that the granularity may be set to any value, such as tenths of seconds, seconds, minutes, etc.) The resulting metric reflects not merely that the song was played once, but how many listeners experienced it and for how long, capturing both reach and depth of engagement.

Beyond basic time-weighted aggregation, the system herein may also derive several secondary analytics from the same dataset. For instance, a “Join Rate” and “Leave Rate” may be used to indicate how many users joined or exited the session during each sampling interval, providing insight into audience reactions to specific tracks or moments. A “Momentum Index” may be computed as the derivative of the listener-count curve, identifying inflection points that correspond to spikes in popularity or drop-off events. The system may further classify these variations into categories, such as growth, stability, or decline, based on pre-defined thresholds or machine-learning-derived clustering.

Each set of track-specific metrics is associated with contextual metadata including broadcast identifier, track identifier, timestamp range, and aggregate listener demographics where available. These records are stored in a database optimized for time-series analysis, allowing for retrospective analytics and trend visualization. The system may present aggregated results to users through dashboards that display, for example, total minutes listened per song, per session, or per geographic region.

At the device level, client applications are designed to minimize bandwidth and power consumption by batching telemetry data and transmitting it only periodically or upon session events such as track changes or user disconnections. In some configurations, devices may also compute partial local metrics, such as total listen duration with start and stop times, and upload summarized data that can be cross-referenced with server logs to validate accuracy. The servers reconcile these records using statistical alignment, optionally compensating for slight timing discrepancies between clients to maintain consistency in the unified analytics dataset.

In addition to individual track analytics, the system can compute Session Influence Profiles, representing the cumulative audience engagement across multiple tracks or over entire broadcasts. These profiles may be used for ranking or discovery, identifying which sessions sustain high audience retention or rapid growth. Because the metrics are derived from raw playback and participation data, they can serve multiple downstream purposes (e.g., content recommendation, performance comparison, or influence scoring) without relying on external models.

Since the architecture supporting these functions mirrors that described above (user devices generate playback events, the control server consolidates them, and the analytics subsystem performs computation and storage), this modular design allows the influence-tracking component to integrate seamlessly with any synchronized streaming framework while remaining independent of the specific content, network, or business context.

Notably, as an additional metric that may be collected, SynQing In/Out may also incorporate performance metrics and recognition features for the SynQers, adding an element of gamification to enhance user engagement. Metrics like “SynQ Minutes” may track the total time a user has SynQed out to others, offering a quantitative measure of their broadcasting activity. Leaderboards showcase top SynQers and hot artists based on listener counts, while SynQ Badges provide users with icons that represent specific performance metrics, such as cumulative SynQ Minutes or number of likes. In certain embodiments, the SynQ Minutes may also be tied to the SynQ Influence Metrics above, in a manner that would show, for example, not only the number of minutes a particular song was heard, but also which SynQers may be credited with those minutes (e.g., “5% came from user123”), allowing artists to recognize their top advocates. These features encourage users to stay active and build recognition within the app's community.

FIG. 6 describes a flow 600 of how listener telemetry is captured for usage-weighted metrics. When streaming a broadcast (block 610), each device periodically records playback status at defined intervals (collect telemetry, block 620), for instance every ten seconds, tagging each record with a session identifier and timestamp. The control server receives these updates to know the song playback seen by the user devices (block 630), aggregates them per session, and aligns them to a global broadcast timeline, determining the total market viewership (block 640) and/or user view duration (block 650). By compiling these intervals, the system reconstructs the number of active listeners for each moment of the stream, i.e., computing total viewer minutes (block 660). This continuous sampling enables precise measurement of total audience exposure and supports later computation of engagement statistics such as total listening time or trend acceleration.

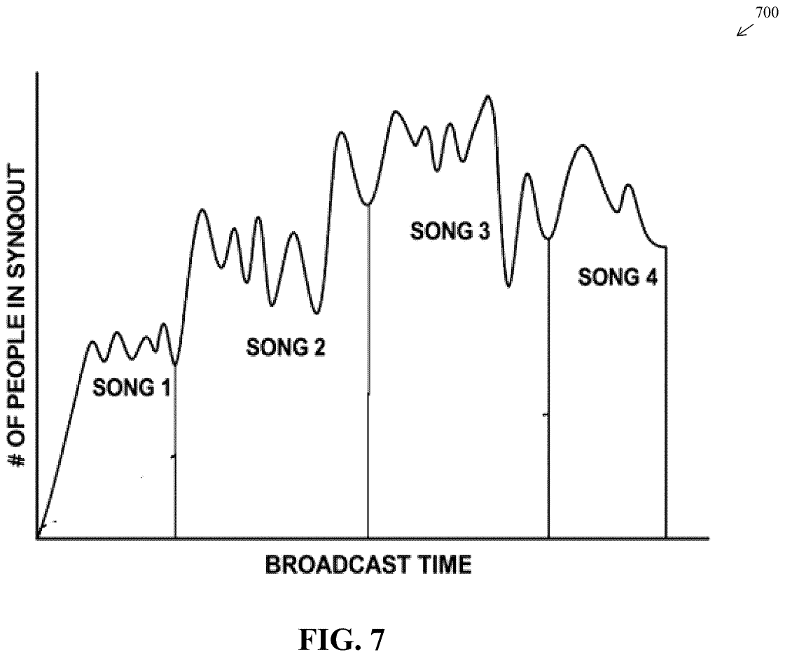

FIG. 7 provides an example graphical representation 700 of listener count as a function of broadcast time. The curve for each track rises and falls as participants join or leave the session. The shaded area under each curve corresponds to cumulative listening exposure, representing the integrated sum of listeners multiplied by listening duration. Boundaries along the time axis mark the start and end of individual songs, enabling per-track segmentation of engagement data. This figure demonstrates how instantaneous listener activity can be transformed into quantitative metrics for later analytics or visualization.

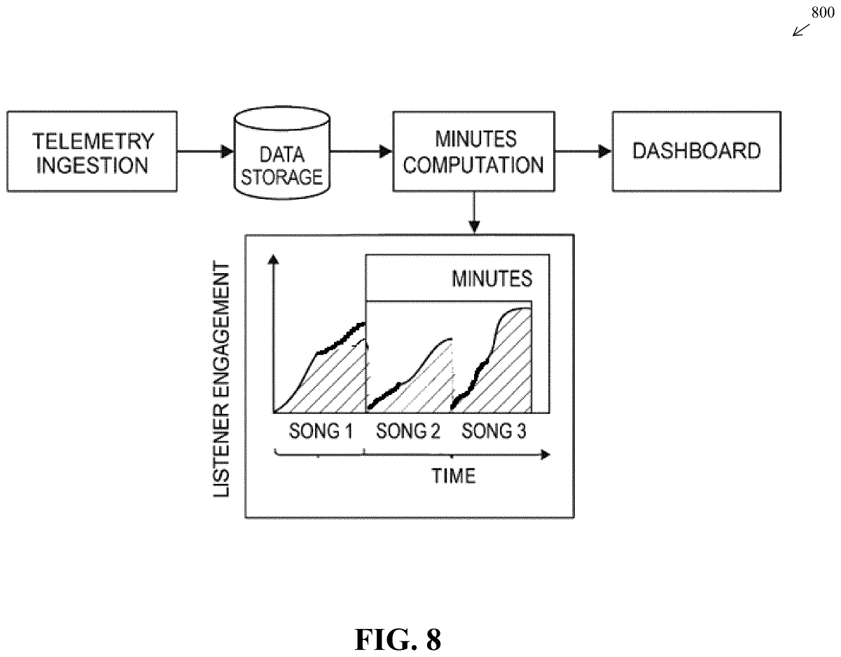

FIG. 8 illustrates the process 800 by which telemetry data is aggregated and transformed into meaningful influence metrics. The workflow begins with ingestion of raw interval reports from multiple devices, followed by normalization to account for latency or sampling differences. The control server computes derived values such as total minutes and engagement ratios, then stores the results in an analytics database. A visualization module retrieves the metrics to generate charts, leaderboards, or heat maps that describe user behavior over time. The diagram emphasizes separation between data acquisition, computation, and presentation, allowing modular scaling and integration with third-party analytical tools.

The disclosed system provides a technically robust and resource-efficient method for deriving real-time engagement analytics within synchronized broadcast environments. By introducing continuous playback telemetry sampling and area-under-curve computation, the invention delivers a fine-grained, quantitative representation of listener participation that traditional “play count” metrics fail to capture. Unlike existing systems that rely solely on discrete play events, this system tracks active participation throughout the entire playback timeline, allowing it to reflect both audience size and attentiveness across each interval of a live stream.

The SynQ Influence Metric (e.g., expressed in cumulative SynQ Minutes) offers a standardized measure of a track's reach and engagement by combining the dimensions of time, concurrency, and listener interaction into a single, scalable metric. This technical construct enables the platform to evaluate the relative impact of songs, artists, or sessions independent of business-layer payout logic, while still supporting use cases such as performance analytics, content discovery ranking, or influencer assessment.

From an architectural perspective, the system's distributed telemetry sampling minimizes network and processing overhead by performing lightweight, periodic reporting rather than continuous streaming of listener data. Server-side aggregation ensures precise time alignment across devices, providing a synchronized and statistically accurate model of audience behavior even in large-scale broadcast scenarios. The analytics derived from these metrics (such as, e.g., join/leave rate, momentum index, and engagement slope) enable powerful insights into audience behavior patterns, fostering a deeper understanding of listener reactions in real time.

Collectively, these advantages establish a data-driven foundation for understanding influence and engagement in live, social audio environments. The result is a scalable analytics layer that can integrate seamlessly into existing broadcast systems, delivering richer, temporally precise insights without compromising efficiency or user experience. Such insights, in certain use cases, may be used for monetary distribution calculations (e.g., artist payouts, influencer rewards, other royalties, etc.), accordingly.

In some implementations, an illustrative method herein for generating usage-weighted influence metrics for a plurality of user devices may comprise: receiving, at the server system, playback telemetry from a plurality of user devices, the playback telemetry identifying one or more audio tracks that were played by each user device and a corresponding playback duration for each of the one or more audio tracks; aggregating, by the server system, the playback telemetry to determine cumulative playback durations of the one or more audio tracks across the plurality of user devices; and computing, by the server system, an influence metric for each of the one or more audio tracks based on the cumulative playback durations, the influence metric representing relative audience engagement within a defined observation period.

In one embodiment, computing the influence metric comprises weighting playback durations by a number of distinct user devices that initiated playback of a corresponding audio track during an observation period.

In one embodiment, the method further comprises: correlating playback start times and stop times received from the plurality of user devices to reconstruct playback sessions and determine continuous listening intervals for each audio track.

In one embodiment, the playback sessions are reconstructed using a tolerance window that accounts for buffering or connection delays between the plurality of user devices.

In one embodiment, the playback telemetry includes explicit playback duration reports transmitted from the plurality of user devices, and wherein the server system uses explicit reports in place of reconstructed start and stop times.

In one embodiment, the method further comprises: normalizing the cumulative playback durations according to a total number of active user devices connected during an observation period to produce a usage-weighted popularity index. In one embodiment, the server system computes separate influence metrics for distinct audience categories comprising at least one of public listeners, followers, friends, or private session participants.

In one embodiment, the method further comprises: associating the playback telemetry with contextual metadata comprising at least one of a broadcast session identifier, a SynQ Space identifier, or a tag identifier, and computing tag-weighted influence metrics that reflect engagement associated with particular topics or genres.

In one embodiment, the server system ranks the one or more audio tracks according to their respective influence metrics and transmits ranking data to user devices for display as trending or top-played lists.

In one embodiment, the method further comprises: generating influence metrics for individual users based on cumulative listening durations, broadcast participation, or interactions within synchronized playback sessions, and storing the influence metrics in association with corresponding user profiles.

In one embodiment, the server system dynamically updates influence metrics in real time as additional playback telemetry is received, and publishes updated rankings or engagement scores without requiring manual aggregation or batch processing.

Note that an illustrative flowchart outlining a procedure (method) in accordance with the method steps described above is effectively contemplated herein, accordingly.

In still other implementations, an illustrative apparatus herein may comprise: one or more network interfaces to communicate with a network; a processor coupled to the one or more network interfaces and configured to execute one or more processes; and a memory configured to store a process that is executable by the processor, the process comprising: receiving playback telemetry from a plurality of user devices, the playback telemetry identifying one or more audio tracks that were played by each user device and a corresponding playback duration for each of the one or more audio tracks; aggregating the playback telemetry to determine cumulative playback durations of the one or more audio tracks across the plurality of user devices; and computing an influence metric for each of the one or more audio tracks based on the cumulative playback durations, the influence metric representing relative audience engagement within a defined observation period.

In still other implementations, a tangible, non-transitory computer-readable medium may store computer-executable instructions that, when executed by one or more processors, cause a device to perform operations comprising: receiving playback telemetry from a plurality of user devices, the playback telemetry identifying one or more audio tracks that were played by each user device and a corresponding playback duration for each of the one or more audio tracks; aggregating the playback telemetry to determine cumulative playback durations of the one or more audio tracks across the plurality of user devices; and computing an influence metric for each of the one or more audio tracks based on the cumulative playback durations, the influence metric representing relative audience engagement within a defined observation period.

In closing, the features described above help to redefine the music streaming experience by integrating social elements, real-time interaction, and community-driven features. The new app distinguishes itself by prioritizing user engagement, collaboration, and personalized content curation, setting a new standard for music streaming platforms.

Illustratively, the techniques described herein may be performed by hardware, software, and/or firmware (e.g., an “apparatus”), such as in accordance with the media collaboration process, process 248 (e.g., a “method”), which may include computer-executable instructions executed by the processor(s) 220 to perform functions relating to the techniques described herein, e.g., in conjunction with corresponding processes of other devices in the computer network as described herein (e.g., on computing devices, servers, controllers, agents, etc.). In addition, the components herein may be implemented on a singular device or in a distributed manner, in which case the combination of executing devices can be viewed as their own singular “device” for purposes of executing the process (e.g., process 248).

While the embodiments described above are presented in the context of an audio synchronization and social streaming application, it will be understood that the inventive concepts disclosed herein are not limited to that particular use case. The systems, methods, and data structures described may be applied to any environment in which synchronized content delivery, social interaction, or distributed user engagement is desired. For example, the same synchronization, control, and engagement mechanisms may be adapted for video, film, podcast, or mixed-media broadcasts, including live event streaming and collaborative video-watching applications.

In certain embodiments, the described features may be implemented in alternative forms of social media platforms unrelated to music. These may include live gaming streams, group chat environments, or content-sharing applications where users co-view or co-listen to shared media. The queuing, voting, and playback control features may similarly extend to collaborative playlists of movies, short clips, educational materials, or user-generated content.

It should also be recognized that the particular architectural arrangements illustrated and described, including separate control and streaming servers, may alternatively be implemented on a unified platform or distributed cloud infrastructure. Various embodiments may incorporate local caching, edge computing, or federated deployment without departing from the scope of the invention.

The specific embodiments, examples, and user interface depictions set forth herein are therefore to be regarded as illustrative rather than limiting. Variations in implementation, data handling, and presentation may be made by one of ordinary skill in the art without departing from the spirit or scope of the invention as defined by the appended claims. Unless expressly stated otherwise, no particular embodiment, component, or configuration described above should be construed as required or exclusive to the claimed invention.

That is, the foregoing description has been directed to specific embodiments. It may be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method executed by a server system for generating usage-weighted influence metrics for a plurality of user devices, the method comprising:
receiving, at the server system, playback telemetry from a plurality of user devices, the playback telemetry identifying one or more audio tracks that were played by each user device and a corresponding playback duration for each of the one or more audio tracks;
aggregating, by the server system, the playback telemetry to determine cumulative playback durations of the one or more audio tracks across the plurality of user devices; and
computing, by the server system, an influence metric for each of the one or more audio tracks based on the cumulative playback durations, the influence metric representing relative audience engagement within a defined observation period.

2. The method of claim 1, wherein computing the influence metric comprises weighting playback durations by a number of distinct user devices that initiated playback of a corresponding audio track during an observation period.

3. The method of claim 1, further comprising:
correlating playback start times and stop times received from the plurality of user devices to reconstruct playback sessions and determine continuous listening intervals for each audio track.

4. The method of claim 3, wherein the playback sessions are reconstructed using a tolerance window that accounts for buffering or connection delays between the plurality of user devices.

5. The method of claim 1, wherein the playback telemetry includes explicit playback duration reports transmitted from the plurality of user devices, and wherein the server system uses explicit reports in place of reconstructed start and stop times.

6. The method of claim 1, further comprising:
normalizing the cumulative playback durations according to a total number of active user devices connected during an observation period to produce a usage-weighted popularity index.

7. The method of claim 6, wherein the server system computes separate influence metrics for distinct audience categories comprising at least one of public listeners, followers, friends, or private session participants.

8. The method of claim 1, further comprising:
associating the playback telemetry with contextual metadata comprising at least one of a broadcast session identifier, a SynQ Space identifier, or a tag identifier, and computing tag-weighted influence metrics that reflect engagement associated with particular topics or genres.

9. The method of claim 1, wherein the server system ranks the one or more audio tracks according to their respective influence metrics and transmits ranking data to user devices for display as trending or top-played lists.

10. The method of claim 1, further comprising:
generating influence metrics for individual users based on cumulative listening durations, broadcast participation, or interactions within synchronized playback sessions, and storing the influence metrics in association with corresponding user profiles.

11. The method of claim 1, wherein the server system dynamically updates influence metrics in real time as additional playback telemetry is received, and publishes updated rankings or engagement scores without requiring manual aggregation or batch processing.

12. An apparatus, comprising:
one or more network interfaces to communicate with a network;
a processor coupled to the one or more network interfaces and configured to execute one or more processes; and
a memory configured to store a process that is executable by the processor, the process comprising:
receiving playback telemetry from a plurality of user devices, the playback telemetry identifying one or more audio tracks that were played by each user device and a corresponding playback duration for each of the one or more audio tracks;
aggregating the playback telemetry to determine cumulative playback durations of the one or more audio tracks across the plurality of user devices; and
computing an influence metric for each of the one or more audio tracks based on the cumulative playback durations, the influence metric representing relative audience engagement within a defined observation period.

13. The apparatus of claim 12, wherein computing the influence metric comprises weighting playback durations by a number of distinct user devices that initiated playback of a corresponding audio track during an observation period.

14. The apparatus of claim 12, wherein the process further comprises:
correlating playback start times and stop times received from the plurality of user devices to reconstruct playback sessions and determine continuous listening intervals for each audio track.

15. The apparatus of claim 14, wherein the playback sessions are reconstructed using a tolerance window that accounts for buffering or connection delays between the plurality of user devices.

16. The apparatus of claim 12, wherein the playback telemetry includes explicit playback duration reports transmitted from the plurality of user devices, and wherein the process uses explicit reports in place of reconstructed start and stop times.

17. The apparatus of claim 12, wherein the process further comprises:
normalizing the cumulative playback durations according to a total number of active user devices connected during an observation period to produce a usage-weighted popularity index.

18. The apparatus of claim 12, wherein the process further comprises:
associating the playback telemetry with contextual metadata comprising at least one of a broadcast session identifier, a SynQ Space identifier, or a tag identifier, and computing tag-weighted influence metrics that reflect engagement associated with particular topics or genres.

19. The apparatus of claim 12, wherein the process ranks the one or more audio tracks according to their respective influence metrics and transmits ranking data to user devices for display as trending or top-played lists.

20. A tangible, non-transitory computer-readable medium storing computer-executable instructions that, when executed by one or more processors, cause a device to perform operations comprising:
receiving playback telemetry from a plurality of user devices, the playback telemetry identifying one or more audio tracks that were played by each user device and a corresponding playback duration for each of the one or more audio tracks;
aggregating the playback telemetry to determine cumulative playback durations of the one or more audio tracks across the plurality of user devices; and
computing an influence metric for each of the one or more audio tracks based on the cumulative playback durations, the influence metric representing relative audience engagement within a defined observation period.
